(19) United States
(12) Patent Application Publication
(10) Pub. No.: US 2026/0038819 A1
(43) Pub. Date: Feb. 5, 2026

(54) ELECTRODE LAYER AND BATTERY

(71) Applicant: TOYOTA JIDOSHA KABUSHIKI KAISHA, Toyota-shi (JP)

(72) Inventors: Mitsutoshi OTAKI, Nagoya-shi (JP); Heidyhodex Visbalmendoza, Nagoya-shi (JP)

(73) Assignee: TOYOTA JIDOSHA KABUSHIKI KAISHA, Toyota-shi (JP)

(21) Appl. No.: 19/063,531

(22) Filed: Feb. 26, 2025

(30) Foreign Application Priority Data
Jul. 30, 2024 (JP) 2024-122989

(51) Int. Cl. H01M 4/38; H01M 10/0562

(52) U.S. Cl. CPC H01M 4/386; H01M 10/0562; H01M 2300/008

(57) ABSTRACT

The present disclosure relates to an electrode layer and a battery. An electrode layer is an electrode layer that contains an electrode active material and a solid electrolyte that contains a halogen element, in which the liberation ratio of the halogen element in the solid electrolyte is less than 12.6%.

### CROSS-REFERENCE TO RELATED APPLICATION

This application claims priority to Japanese Patent Application No. 2024-122989 filed on Jul. 30, 2024. The disclosure of the above-identified application, including the specification, drawings, and claims, is incorporated by reference herein in its entirety.

### BACKGROUND

### 1. Technical Field

The present disclosure relates to an electrode layer and a battery.

### 2. Description of Related Art

Various technologies related to a battery disclosed in Japanese Unexamined Patent Application Publication No. 2023-098419 (JP 2023-098419 A) have been proposed.

### SUMMARY

JP 2023-098419 A discloses a negative electrode composite material containing a Si active material, a solid electrolyte, and an organic solvent. In an electrode layer containing a solid electrolyte, when charge and discharge cycles are repeated, the solid electrolyte deteriorates. As a result, the resistance of the battery easily increases.

The present disclosure has been made in view of the above circumstance, and has a main object to provide an electrode layer that curbs the increase in resistance due to charging and discharging.

The present disclosure includes the following aspects.
<1> An electrode layer containing an electrode active material and a solid electrolyte that contains a halogen element, wherein a liberation ratio of the halogen element in the solid electrolyte is less than 12.6%.
<2> The electrode layer according to <1>, wherein the electrode active material is a Si active material.
<3> The electrode layer according to <1> or <2>, wherein the liberation ratio of the halogen element in the solid electrolyte is 6.2% or more and 8.4% or less.
<4> A battery comprising a positive electrode layer, an electrolyte layer, and a negative electrode layer, in this order, wherein the negative electrode layer is the electrode layer according to any one of <1> to <3>.
<5> The battery according to <4>, wherein the battery is an all-solid-state battery in which the electrolyte layer contains a solid electrolyte.

The present disclosure exerts an effect of obtaining an electrode layer that curbs the increase in resistance due to charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a battery in the present disclosure.

### DETAILED DESCRIPTION OF EMBODIMENTS

An embodiment of the present disclosure will be described below. Items (for example, a general configuration and production process of an electrode layer that does not characterize the present disclosure) that are other than matters particularly mentioned in the present specification and that are necessary for carrying out the present disclosure can be regarded as matters that are designed based on the related art by a person skilled in the field. The present disclosure can be carried out based on contents disclosed in the present specification and common technical knowledge in the field.

In the present disclosure, unless otherwise noted, the average particle diameter of particles is the value of a median diameter (D50) that is a particle diameter at an integrated value of 50% in a volume-basis particle size distribution that is measured by a laser diffraction-scatter particle diameter distribution measurement.

### A. Electrode Layer

The present disclosure provides an electrode layer containing an electrode active material and a solid electrolyte that contains a halogen element, in which the liberation ratio of the halogen element in the solid electrolyte is less than 12.6%.

In the electrode layer containing the solid electrolyte that contains the halogen element, when charge and discharge cycles are repeated, the halogen element in the solid electrolyte, as exemplified by iodine, desorbs, the solid electrolyte deteriorates, and the ion conductibility of the solid electrolyte decreases. It have been found that it is possible to restrain the desorption of the halogen element by controlling the liberation ratio of the halogen element in the solid electrolyte as a measure, and as a result, it is possible to restrain the increase in the resistance of the battery due to the repetition of charging and discharging.

### 1. Electrode Active Material

The electrode active material in the present disclosure is a negative electrode active material in the case where the electrode layer is a negative electrode layer, and is a positive electrode active material in the case where the electrode layer is a positive electrode layer.

As the negative electrode active material in the present disclosure, there are a Si active material, a carbon active material, an oxide active material, and a Li active material. Examples of the Si active material include an elemental Si, a Si alloy, a Si oxide, and a Si carbide. The Si alloy is an alloy that contains Si as a main component. Examples of metals other than Si in the Si alloy include Na, W, Mo, Cr, V, Nb, Fe, Ti, Zr, and Hf. As the metal other than Si, the Si alloy may contain only one kind, or may contain two or more kinds. Examples of the Si oxide include SiO. Further, examples of the Si carbide include SiC.

Examples of the carbon active material include graphite, hard carbon, and soft carbon.

Examples of the oxide active material include lithium titanate.

Examples of the Li active material include an elemental Li and a Li alloy. As a metal element that is contained in the Li alloy and that is other than lithium, there are Mg, Ag, In, Sn, Si, Ga, Au, and Pt.

Examples of the positive electrode active material in the present disclosure include an oxide active material. Examples of the oxide active material include bedded salt type active materials such as LiCoO₂, LiMnO₂, LiNiO₂, LiVO₂, and LiNi_{1/3}Co_{1/3}Mn_{1/3}O₂, spinel type active materials such as LiMn₂O₄, Li₄Ti₅O₁₂, and Li(Ni_{0.5}Mn_{1.5})O₄, and olivine type active materials such as LiFePO₄, LiMnPO₄, LiNiPO₄, and LiCoPO₄. A coat layer containing a Li-ion conducting compound may be formed on a surface of the positive electrode active material. This is because the reaction between the positive electrode active material and the solid electrolyte (particularly, a sulfide solid electrolyte) can be restrained. Examples of the Li-ion conducting compound include B₂O₃, Li₂B₄O₇, LiBPO₄, Li₃PO₄, LiPO₃, and LiNbO₃. The thickness of the coat layer is 1 nm or more and 30 nm or less, for example. The coverage of the Li-ion conducting compound that covers the positive electrode active material is 70% or more, for example, and may be 90% or more, or may be 100%. The covering method for the Li-ion conducting compound is not particularly limited, and a known conventional method can be employed when appropriate.

The shape of the electrode active material is ordinarily a particle form. The electrode active material may have a primary particle, or may have a secondary particle in which primary particles are aggregated. Further, the electrode active material may be a porous material. That is, the electrode active material may include voids in the interior of the primary particle. The ratio (void ratio) of voids in the primary particle is 4% or more, for example, and may be 10% or more. Further, the above void ratio is 40% or less, for example, and may be 20% or less. For example, the void ratio can be evaluated in the following procedure. First, a section of the electrode layer containing the electrode active material is exposed by ion milling processing. Then, the section is observed by a scanning electron microscope (SEM), and the photograph of the particle is acquired. From the obtained photograph, an electrode active material portion and a void portion are distinguished and are binarized using image analysis software. The areas of the electrode active material portion and the void portion are evaluated, and the void ratio (%) is calculated from the following expression.

Void Ratio (%)=100×(Void Portion Area)/((Electrode Active Material Portion Arca)+(Void Portion Arca))

The electrode active material may be a crystalline material, or may be an amorphous material.

In the case where the electrode active material is a Si active material and is a crystalline material, the electrode active material ordinarily includes a Si crystal phase. Examples of the Si crystal phase include a diamond type crystal phase. A general Si contains the diamond type crystal phase as the Si crystal phase. The electrode active material may contain the diamond type crystal phase, as a main phase of the Si crystal phase.

Other examples of the Si crystal phase include a silicon clathrate type crystal phase. The silicon clathrate type crystal phase may be a silicon clathrate type I crystal phase, or may be a silicon clathrate type II crystal phase. In the silicon clathrate type crystal phase, a plurality of Si elements constitutes a polyhedron (cage) including a pentagonal shape or a hexagonal shape. This polyhedron includes, in the interior, a space that can envelop a metal ion such as a Li ion. When the metal ion is inserted into this space, the volume change due to charging and discharging can be restrained. The Si active material, as a main phase of the Si crystal phase, may contain the silicon clathrate type I crystal phase, or may be the silicon clathrate type II crystal phase. Examples of the production method for the silicon clathrate type crystal phase includes a method of reacting Na and Si to produce an Na—Si alloy and thereafter performing the firing of the Na—Si alloy to remove Na from the Na—Si alloy.

The average particle diameter (D50) of the electrode active material is not particularly limited. The average particle diameter (D50) of the electrode active material is 0.01 μm or more and 50 μm or less, for example, and may be 0.5 μm or more and 30 μm or less.

The BET specific surface area of the electrode active material is not particularly limited. The BET specific surface area of the electrode active material is 30 m²/g or more, for example, and may be 40 m²/g or more, may be 50 m²/g or more, or may be 60 m²/g or more. On the other hand, the BET specific surface area of the electrode active material is 150 m²/g or less, for example.

The electrode active material may be covered with a covering layer containing the solid electrolyte, or may be avoided from being covered. The solid electrolyte composing the covering layer is not particularly limited, and there are solid electrolytes in “2. Solid Electrolyte” described later. Among them, a sulfide solid electrolyte may be adopted. The coverage of the covering layer for the electrode active material is 50% or more, for example, and may be 70% or more, or may be 90% or more. The thickness of the covering layer is 1 nm or more and 100 nm or less, for example, and may be 5 nm or more and 50 nm or less, or may be 10 nm or more and 30 nm or less.

The ratio of the electrode active material in the electrode layer is 20 mass % or more, for example, and may be 30 mass % or more, or may be 40 mass % or more. When the ratio of the electrode active material is excessively small, there is a possibility that a sufficient energy density cannot be obtained. On the other hand, the ratio of the electrode active material in the electrode layer is 80 mass % or less, for example, and may be 70 mass % or less, or may be 60 mass % or less. When the ratio of the electrode active material is excessively large, there is a possibility that the ion conductibility and electron conductibility in the electrode layer relatively decrease.

### 2. Solid Electrolyte

The electrode layer contains the solid electrolyte. The ion conductibility in the electrode layer is enhanced by the addition of the solid electrolyte. The solid electrolyte may be an inorganic solid electrolyte such as a sulfide solid electrolyte, a halide solid electrolyte, an oxide solid electrolyte, a hydride complex solid electrolyte, or may be an organic solid electrolyte such as a gel electrolyte. Among them, the solid electrolyte may be the sulfide solid electrolyte. This is because the sulfide solid electrolyte has a high ion conductibility. The sulfide solid electrolyte is an electrolyte that contains the S element as a main component of the anion constituent.

The solid electrolyte contained in the electrode layer only needs to be a solid electrolyte containing the halogen element. The liberation ratio of the halogen element in the solid electrolyte only needs to be less than 12.6%, and may be 6.2% or more and 8.4% or less.

The liberation ratio of the halogen element in the solid electrolyte can be calculated by comparing a map for a sulfur element S and a map for a halogen element X that are obtained by SEM-EDX or STEM-EDX and evaluating the ratio of the area (the area of only X) of a region where only the halogen element X is detected to the total area of the area (the area of the overlap of S and X) of a region where both of the sulfur element S and the halogen element X are detected and the area of the region where only the halogen element X is detected.

Liberation Ratio (%)=100×(Area of Only X)/(Area of Overlap of S and X)+(Area of Only X)

The liberation ratio of the halogen element in the solid electrolyte may be controlled by altering conditions about a drying temperature, drying time, and drying atmosphere of a slurry for electrode layer production. The drying temperature of the slurry for electrode layer production may be 150° C. to 250° C. The drying time of the slurry of electrode layer production may be 30 minutes to 3 hours, or may be 1 hour to 2 hours. The drying atmosphere of the slurry for electrode layer production may be a nitrogen atmosphere, an Ar atmosphere, a vacuum atmosphere, or the like.

The sulfide solid electrolyte ordinarily contains at least the Li element and the S element. The sulfide solid electrolyte may further contain an Me element (Me is at least one kind of P, As, Sb, Si, Ge, Sn, B, Al, Ga, and In). Further, the sulfide solid electrolyte may contain a halogen element such as F, Cl, Br, and I.

The sulfide solid electrolyte may be a glass type (amorphous type) sulfide solid electrolyte, may be a glass ceramics type sulfide solid electrolyte, or may be a crystalline type sulfide solid electrolyte. The sulfide solid electrolyte may include a crystal phase. Examples of the above crystal phase include a Thio-LISICON type crystal phase, an argyrodite type crystal phase, and a LGPS type crystal phase.

The composition of the sulfide solid electrolyte is not particularly limited, and examples of the composition of the sulfide solid electrolyte include xLi₂S·(1-x)P₂S₅ (0.5≤x<1) and yLiI·zLiBr·(100-y-z)(xLi₂S·(1-x)P₂S₅)(0.5≤x<1, 0≤y≤30, 0≤z≤30). In the compositions, x may satisfy 0.7≤x≤0.8. Further, other examples of the composition of the sulfide solid electrolyte include Li₇₋ₓPS₆₋ₓXₓ. X is at least one kind of F, Cl, Br, and I, and x satisfies 0≤x<2. Further, other examples of the composition of the sulfide solid electrolyte include Li₄₋ₓMe₁₋ₓPₓS₄ (0<x<1). Me is at least one kind of Al, Zn, In, Ge, Si, Sn, Sb, Ga, and Bi. Examples of the sulfide solid electrolyte include LiI—LiBr—Li₂S—P₂S₅, LiI—Li₂S—P₂S₅, LiI—Li₂S—P₂O₅, and LiI—Li₃PO₄—P₂S₅.

The form of the solid electrolyte may be a particle form from the standpoint of ease of handling. Further, the average particle diameter (D50) of solid electrolyte particles is not particularly limited, and may be 1 nm to 100 μm.

The ratio of the solid electrolyte in the electrode layer may be 10 mass % or more, for example. When the ratio of the solid electrolyte is excessively small, there is a possibility that ion conducting paths in the electrode layer become insufficient. On the other hand, the ratio of the solid electrolyte in the electrode layer may be 60 mass % or less, for example. When the ratio of the solid electrolyte is excessively large, there is a possibility that the ratio of the electrode active material becomes small and the energy density becomes low, relatively.

### 3. Conductive Material

The electrode layer may contain a conductive material. The electron conductibility in the electrode layer is enhanced by the addition of the conductive material. Examples of the conductive material include a carbon material, a metal particle, and a conductive polymer. Examples of the carbon material include particulate carbon materials such as acetylene black (AB) and Ketjen black (KB), and fibrous carbon materials such as a vapor-grown carbon fiber (VGCF), a carbon nanotube (CNT) and a carbon nanofiber (CNF).

The ratio of the conductive material in the electrode layer may be 0.1 mass % or more, for example. When the ratio of the conductive material is excessively small, there is a possibility that electron conducting paths in the electrode layer become insufficient. On the other hand, the ratio of the conductive material in the electrode layer may be 5 mass % or less, for example. When the ratio of the conductive material is excessively large, there is a possibility that the ratio of the electrode active material becomes small and the energy density becomes low, relatively.

### 4. Binder

The electrode layer may contain a binder. Examples of the binder include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymer (SIS), and ethylene-propylene-diene copolymer (EPDM).

The ratio of the binder in the electrode layer may be 0.5 mass % or more, for example. When the ratio of the binder is excessively small, there is a possibility that the increase in resistance due to charging and discharging cannot be sufficiently reduced. On the other hand, the ratio of the binder in the electrode layer may be 5 mass % or less, for example. When the ratio of the binder is excessively large, there is a possibility that the ratio of the electrode active material becomes small and the energy density becomes low, relatively.

The electrode layer in the present disclosure is ordinarily used in a battery. The electrode layer may be the negative electrode layer, or may be the positive electrode layer. The thickness of the electrode layer is 0.1 μm or more and 1000 μm or less, for example, and may be 1 μm or more and 500 μm or less, or may be 30 μm or more and 100 μm or less.

The production method for the electrode layer is not particularly limited, and for example, includes a preparing step of preparing the above electrode active material, a mixing step of mixing the above electrode active material, the above solid electrolyte, and a solvent, to obtain an electrode slurry, and an electrode layer forming step of forming the electrode layer using the above electrode slurry. In the present disclosure, such a production method for the electrode layer can be provided.

The above preparing step is a step of preparing the above electrode active material. The above electrode active material has the same contents as the contents described in “1. Electrode Active Material”. The mixing step is a step of mixing the above electrode active material, the above solid electrolyte, and a solvent, to obtain an electrode slurry. In the present disclosure, it is possible to provide the electrode slurry containing the above electrode active material, the above solid electrolyte, and the above solvent.

Examples of the solvent (dispersion medium) may include tetralin, di-isobutyl ketone, butyl butyrate, mesitylene, heptane, dibutyl ether, decane, and toluene, and may contain two or more kinds of them.

The above electrode layer forming step is a step of forming the electrode layer using the above electrode slurry. The method for forming the electrode layer is not particularly limited, and a known method can be employed. Examples of the method for forming the electrode layer include a method of applying the electrode slurry on an electrode current collector and performing drying. In the formation of the electrode layer, a press process of pressing the electrode layer in a thickness direction may be performed. Examples of the press process include a roller press and a flat-plate press.

### B. Battery

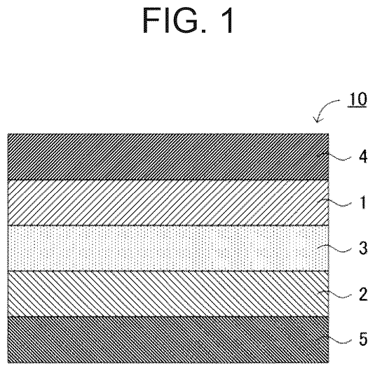

FIG. 1 is a schematic sectional view illustrating a battery in the present disclosure. A battery 10 shown in FIG. 1 includes a positive electrode layer 1, a negative electrode layer 2, an electrolyte layer 3 that is disposed between the positive electrode layer 1 and the negative electrode layer 2, a positive electrode current collector 4 that performs current collection for the positive electrode layer 1, and a negative electrode current collector 5 that performs current collection for the negative electrode layer 2. In the present disclosure, the electrode layer described in “A. Electrode Layer” is the positive electrode layer 1 or the negative electrode layer 2.

The present disclosure provides a battery that curbs the increase in resistance due to charging and discharging, by using the above-described electrode layer. The electrode layer may be a negative electrode layer, or may be a positive electrode layer as described above, and preferably, should be a negative electrode layer.

### 1. Negative Electrode Layer

The negative electrode layer is a layer that contains at least a negative electrode active material. Further, the negative electrode layer may contain at least one of a solid electrolyte, a solvent component, a conductive material, and a binder, as necessary. Furthermore, in the case where the electrode layer in the present disclosure is the negative electrode layer, the negative electrode layer contains at least the negative electrode active material and the solid electrolyte that contains the halogen element.

The negative electrode active material, solid electrolyte, solvent component, conductive material and binder that are used in the negative electrode layer have the same contents as the contents described in “A. Electrode Layer”, and therefore, descriptions thereof are omitted.

The mass ratio between the negative electrode active material and the solid electrolyte may be 85:15 to 30:70, or may be 80:20 to 40:60.

### 2. Positive Electrode Layer

The positive electrode layer is a layer that contains at least a positive electrode active material. Further, the positive electrode layer may contain at least one of a solid electrolyte, a solvent component, a conductive material, and a binder, as necessary. Furthermore, in the case where the electrode layer in the present disclosure is the positive electrode layer, the positive electrode layer contains at least the positive electrode active material and the solid electrolyte that contains the halogen element.

The positive electrode active material, solid electrolyte, solvent component, conductive material and binder that are used in the positive electrode layer have the same contents as the contents described in “A. Electrode Layer”, and therefore, descriptions thereof are omitted.

The mass ratio between the positive electrode active material and the solid electrolyte may be 85:15 to 30:70, or may be 80:20 to 50:50.

### 3. Electrolyte Layer

The electrolyte layer is a layer that is formed between the positive electrode layer and the negative electrode layer, and contains at least an electrolyte. The electrolyte may be a solid electrolyte, or may be a liquid electrolyte (electrolytic solution).

The electrolytic solution may contain a supporting electrolyte and a solvent. Examples of the supporting electrolyte (lithium salt) of an electrolytic solution having lithium-ion conductibility include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃. Examples of the solvent that is used in the electrolytic solution include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). It is preferable that the electrolytic solution contains two or more kinds of solvents.

The solid electrolyte has the same contents as the contents described in “A. Electrode Layer”, and therefore, descriptions thereof are omitted. The solid electrolyte that is used in the electrolyte layer may contain the halogen element, or may contain no halogen element.

One kind of solid electrolyte or two or more kinds of solid electrolytes can be used. Further, in the case where two or more kinds of solid electrolytes are used, the two or more kinds of solid electrolytes may be mixed, or a multi-layer structure may be adopted by forming a layer for each of the two or more kinds of solid electrolytes.

The ratio of the solid electrolyte in the electrolyte layer is not particularly limited. The ratio of the solid electrolyte in the electrolyte layer is 50 mass % or more, for example, and may be in a range of 60 mass % or more and 100 mass % or less, may be in a rage of 70 mass % or more and 100 mass % or less, or may be 100 mass %. The solid electrolyte may contain an electrolytic solution by less than 10 mass % of the total electrolyte amount. The solid electrolyte may be a composite solid electrolyte that contains an inorganic solid electrolyte and a polymer electrolyte.

In the case where the electrolyte layer is a solid electrolyte layer, the solid electrolyte layer contains the solid electrolyte, and contains a binder and the like as necessary.

Examples of the binder include the above-described binders that can be contained in the electrode layer.

In the case where the solid electrolyte layer contains the binder, the content of the binder may be 0 mass % to 10 mass % of the total amount of the solid electrolyte layer.

The thickness of the electrolyte layer is 0.1 μm or more and 1000 μm or less, for example, and may be 0.1 μm or more and 500 μm or less, or may be 0.1 μm or more and 100 μm or less.

### 4. Other Configurations

The battery in the present disclosure may include a positive electrode current collector that performs current collection for the positive electrode layer and a negative electrode current collector that performs current collection for the negative electrode layer.

Examples of the material of the positive electrode current collector include SUS, Cr, Au, Pt, Zn, aluminum, copper, nickel, iron, titanium, and carbon. The thickness of the positive electrode current collector is 0.1 μm or more and 100 μm or less, for example. The shape of the positive electrode current collector may be a foil shape, a plate shape, or the like. The positive electrode current collector may be configured such that a buffer layer, an elastic layer, or a positive temperature coefficient (PTC) thermistor layer is disposed on a surface.

Examples of the material of the negative electrode current collector include SUS, aluminum, copper, nickel, iron, titanium, and carbon. Examples of the shape of the negative electrode current collector include a foil shape and a plate shape. The shape of the negative electrode current collector in planar view is not particularly limited. Examples of the shape of the negative electrode current collector in planar view include a circular shape, an elliptical shape, a rectangular shape, and an arbitrary polygonal shape. Further, the thickness of the negative electrode current collector differs depending on the shape, and may be in a range of 1 μm to 50 μm, for example. The negative electrode current collector may be configured such that a buffer layer, an elastic layer, or a PTC thermistor layer is disposed on a surface.

The battery in the present disclosure may further include a confining jig that gives confining pressure to the positive electrode layer, the electrolyte layer, and the negative electrode layer, along the thickness direction. Particularly, in the case where the electrolyte layer is a solid electrolyte layer, the confining pressure may be given for forming a good ion conducting path and electron conducting path. The confining pressure is 0.1 MPa, for example, and may be 1 MPa or higher, or may be 5 MPa or higher. On the other hand, the confining pressure is 100 MPa or lower, for example, and may be 50 MPa or lower, or may be 20 MPa or lower.

### 5. Battery

The kind of the battery in the present disclosure is not particularly limited, and is typically a lithium-ion battery. Further, the battery in the present disclosure may be a liquid-state battery in which the electrolyte layer contains an electrolytic solution, or may be a solid-state battery in which the electrolyte layer contains a solid electrolyte. The solid-state battery may be a semi-solid-state battery, or may be an all-solid-state battery. In the present disclosure, the semi-solid-state battery is a battery in which the electrolyte layer includes an inorganic solid electrolyte and a liquid component (for example, ionic liquid). In the present disclosure, the all-solid-state battery is a battery in which the electrolyte layer includes only an inorganic solid electrolyte as the electrolyte. Further, the battery in the present disclosure may be a primary battery, or may be a secondary battery, and preferably, should be a secondary battery. This is because the secondary battery can be repeatedly charged and discharged and is useful as an in-vehicle battery, for example.

The shape of the battery is not particularly limited, and may be a coin type, a cylinder type, a square type, a sheet type, a button type, a flat type, or a lamination type, for example.

Examples of the use application of the battery include an electric power source of a vehicle such as a hybrid electric vehicle (HEV), a plug-in hybrid electric vehicle (PHEV), a battery electric vehicle (BEV), a gasoline vehicle, and a diesel vehicle. Particularly, the battery may be used as an electric power source for the drive of the hybrid electric vehicle (HEV), the plug-in hybrid electric vehicle (PHEV), or the battery electric vehicle (BEV). Further, the battery may be used as an electric power source of a movable body (for example, a train, a ship, and an airplane) other than a vehicle, or may be used as an electric power source of an electric product such as an information processing device.

The present disclosure is not limited to the above embodiment. The above embodiment is an example, and the technical scope of the present disclosure includes all embodiments that have substantially identical configurations to the technical idea described in the claims in the present disclosure and that exert the same function effect.

### Example 1

### Production of Electrode Active Material

Li metal and Si powder were weighted such that the molar ratio was 4:1, were mixed in a mortar at room temperature under an Ar atmosphere for 0.5 hours, and thereby were reacted. Thereby, Li₄Si was obtained. The obtained Li₄Si was reacted with ethanol under the Ar atmosphere. The obtained reaction product is thought to contain Si and CH₃CH₂OLi. This reaction product was filtered, and a solid content separated by filtering was dried at 120° C. for 3 hours or more, so that a powdery porous Si was obtained.

Using the obtained porous Si, a Na—Si alloy was produced, while NaH was used as a Na source. As NaH, NaH that was previously washed by hexane was used. NaH and the porous Si were weighted such that the molar ratio was 1.05:1, and were mixed using a cutter mill. The mixture of NaH and the porous Si was heated at 475° C. under the Ar atmosphere in a heating furnace for 40 hours, and thereby, a powdery Na—Si alloy was obtained.

Using the obtained Na—Si alloy, furthermore, a silicon clathrate generation by a solid phase method was performed while AlF₃ was used as a Na trapping agent. The Na—Si alloy and AlF₃ were weighted such that the molar ratio was 1:0.35, and were mixed using a cutter mill, so that a reaction material was obtained. The obtained powdery reaction material was put in a reaction container made of stainless steel, and was heated and reacted at 310° C. under the Ar atmosphere in the heating furnace for 60 hours, so that a precursor active material was obtained.

The obtained precursor active material is thought to contain NaF and Al as by-products. Hence, the precursor active material was washed using a mixed solvent in which HNO₃ and H₂O were mixed at a volume ratio of 10:90. Thereby, the by-products in the reaction product were removed. After the washing, filtering was performed, and a solid content separated by filtering was dried at 120° C. for 3 hours or more, so that a porous clathrate Si was obtained as an electrode active material.

For the obtained electrode active material, an X-ray diffraction (XRD) measurement in which a CuKα ray was used was performed. As a result, it was confirmed that the electrode active material included the silicon clathrate type II crystal phase as a main phase.

### Production of Negative Electrode

A 5 mass % di-isobutyl ketone solution containing the obtained electrode active material, a sulfide solid electrolyte (LiI—Li₂S—P₂S₅ glass ceramic), a conductive material (VGCF) and a binder (PVDF binder), and di-isobutyl ketone as a solvent for negative electrode slurry production were added in a polypropylene container, and were stirred for 30 seconds by the ultrasonic dispersion device (UH-50 manufactured by SMT CO., LTD). Next, the container was shaken for 30 minutes by a shaker (TTM-1 manufactured by SIBATA SCIENTIFIC TECHNOLOGY LTD.), so that a negative electrode slurry was obtained. The obtained negative electrode slurry was applied on a negative electrode current collector (Cu foil; manufactured by UACJ Corporation) by a blade method using an applicator, and was dried on a hot plate at 185° C. under the Ar atmosphere for 1 hour. Thereby, a negative electrode including the negative electrode current collector and the negative electrode layer was obtained.

### Production of Positive Electrode.

A 5 mass % butyl butyrate solution containing a positive electrode active material (LiNi_{1/3}Co_{1/3}Mn_{1/3}O₂; average particle diameter 6 μm), a sulfide solid electrolyte (LiI—Li₂S—P₂S₅ glass ceramic), a conductive material (VGCF) and a PVDF binder, and butyl butyrate were added in a polypropylene container, and were stirred for 30 seconds by the ultrasonic dispersion device (UH-50 manufactured by SMT CO., LTD). Next, the container was shaken for 3 minutes by the shaker (TTM-1 manufactured by SIBATA SCIENTIFIC TECHNOLOGY LTD.). Furthermore, the container was stirred for 30 seconds by the ultrasonic dispersion device and was shaken for 3 minutes by the shaker, so that a positive electrode slurry was obtained. The obtained positive electrode slurry was applied on a positive electrode current collector (Al foil; manufactured by SHOWA DENKO K.K.) by the blade method using the applicator, and was dried on the hot plate at 100° C. under the Ar atmosphere for 30 minutes. Thereby, a positive electrode including the positive electrode current collector and the positive electrode layer was obtained. The area of the positive electrode layer was smaller than the area of the negative electrode layer.

### Production of Solid Electrolyte Layer

A 5 mass % heptane solution containing a sulfide solid electrolyte (LiI—Li₂S—P₂S₅ glass ceramic) and a BR binder, and heptane were added in a polypropylene container, and were stirred for 30 seconds by the ultrasonic dispersion device (UH-50 manufactured by SMT CO., LTD). Next, the container was shaken for 30 minutes by the shaker (TTM-1 manufactured by SIBATA SCIENTIFIC TECHNOLOGY LTD.), so that a slurry was obtained. The obtained slurry was applied on a release sheet (Al foil) by the blade method using the applicator, and was dried on the hot plate at 100° C. for 30 minutes. Thereby, a transfer member including the release sheet and the solid electrolyte layer was obtained.

### Production of All-Solid-State Battery

A solid electrolyte layer for joining was disposed on the positive electrode layer in the positive electrode, was set in a roll press machine, and was pressed at 100 kN/cm at 165° C. Thereby, a first laminated body was obtained. Next, the negative electrode was set in the roll press machine, and was pressed at 60 kN/cm at 25° C. Thereby, the pressed negative electrode was obtained. Thereafter, the solid electrolyte layer for joining and the transfer member were disposed in the order from the negative electrode layer side. On this occasion, the solid electrolyte layer for joining and the solid electrolyte layer in the transfer member were disposed so as to face each other. The obtained laminated body was set in a planar uniaxial press machine, and was temporarily pressed at 100 MPa at 25° C. for 10 seconds. Thereafter, the release sheet was released from the solid electrolyte layer. Thereby, a second laminated body was obtained. Next, the solid electrolyte layer for joining in the first laminated body and the solid electrolyte layer in the second laminated body were disposed so as to face each other, were set in the planar uniaxial press machine, and were pressed at 200 MPa at 120° C. for 1 minute. Thereby, an all-solid-state battery was obtained. The produced all-solid-state battery was confined at a predetermined confining pressure using a confining jig.

### Comparative Example 1

An all-solid-state battery was obtained similarly to Example 1, except that the negative electrode slurry applied on the negative electrode current collector was dried on the hot plate at 170° C. under the Ar atmosphere for 1 hour in the production of the negative electrode.

### Example 2

An all-solid-state battery was obtained similarly to Example 1, except that the negative electrode slurry applied on the negative electrode current collector was dried on the hot plate at 170° C. under the Ar atmosphere for 1 hour and thereafter was further dried on the hot plate at 200° C. under a vacuum environment for 1 hour in the production of the negative electrode.

### Measurement of Resistance Increase Amount

A charge-discharge test was performed for the all-solid-state batteries obtained in Examples 1 and 2 and Comparative Example 1. Specifically, first, CCCV charging was performed at 0.1 C until the voltage became 4.15 V, and discharging was performed at 1 C until the voltage became 2.5 V.

Thereafter, CCCV charging was performed at ⅓ C until the voltage became 4.15 V, and discharging was performed at ⅓ C for 5 seconds. Then, from the value of the voltage drop, an initial resistance was evaluated by a DCIR method. CCCV discharging was performed at ⅓ C until the voltage became 2.5 V.

Next, 50 charge and discharge cycles in which CCCV charging was performed at ⅓ C until the voltage became 4.15 V and CCCV discharging was performed at ⅓ C until the voltage became 2.5 V were repeated. Thereafter, the resistance after the charging and discharging was evaluated similarly to the above method. The difference between the resistance after the charging and discharging and the initial resistance was evaluated as a resistance increase amount. The results are shown in Table 1. In Table 1, resistance increase amounts are relative values when the result in Comparative Example 1 is regarded as 100.

### Liberation Ratio Measurement

The measurement of the liberation ratio of the I element in the solid electrolyte in the negative electrode layer included in the all-solid-state battery after the charge-discharge test was performed for each of the all-solid-state batteries in Examples 1 and 2 and Comparative Example 1.

The liberation ratio of the halogen element in the solid electrolyte was calculated by comparing a map for a sulfur element S and a map for an iodine element I that were obtained by STEM-EDX and evaluating the ratio of the area (the area of only I) of a region where only the iodine element I was detected to the total area of the area (the area of the overlap of S and I) of a region where both of the sulfur element S and the iodine element I were detected and the area of the region where only the iodine element I was detected. The results are shown in Table 1.

TABLE 1

| | Liberation | Resistance |
|---|---|---|
| | Ratio | Increase Amount |
| | % | (relative value) |
| Comparative Example 1 | 12.6 | 100 |
| Example 1 | 8.4 | 88 |
| Example 2 | 6.2 | 73 |

As shown in Table 1, in Examples 1 and 2, the liberation ratio of the iodine element in the solid electrolyte was lower than in Comparative Example 1, and it has been confirmed that the resistance increase amount was reduced. It is estimated that the deterioration of the solid electrolyte was restrained because the liberation ratio of the iodine element in the solid electrolyte was low.

What is claimed is:

1. An electrode layer containing an electrode active material and a solid electrolyte that contains a halogen element, wherein a liberation ratio of the halogen element in the solid electrolyte is less than 12.6%.

2. The electrode layer according to claim 1, wherein the electrode active material is a Si active material.

3. The electrode layer according to claim 1, wherein the liberation ratio of the halogen element in the solid electrolyte is 6.2% or more and 8.4% or less.

4. A battery comprising a positive electrode layer, an electrolyte layer, and a negative electrode layer, in this order, wherein the negative electrode layer is the electrode layer according to claim 1.

5. The battery according to claim 4, wherein the battery is an all-solid-state battery in which the electrolyte layer contains a solid electrolyte.
